(19) United States
(12) Patent Application Publication
(10) Pub. No.: US 2013/0278060 A1
(43) Pub. Date: Oct. 24, 2013

(54) MINIMUM OUTPUT CURRENT ADAPTING CIRCUIT AND MOTHERBOARD USING SAME

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: SONG-LIN TONG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/863,340

(22) Filed: Apr. 15, 2013

(30) Foreign Application Priority Data
Apr. 20, 2012 (CN) 201210117501.9

(51) Int. Cl. H02J 1/00

(52) U.S. Cl. CPC H02J 1/00
USPC 307/31

(57) ABSTRACT

A minimum output current adapting circuit draws currents from a plurality of power ports of a power supply unit (PSU). The current adapting circuit includes a plurality of current adapting units and a control unit. Each current adapting unit is electronically connected to one of the power ports. Each current adapting unit is configured to increase an output current of the power port, to facilitate the output current of the power port to be greater than a request minimum output current of the power port. The control unit is electronically connected to the PSU and a processor powered by the PSU, the control unit is configured to activate each current adapting unit when the PSU starts to work, and inactivate each current adapting unit after the processor is powered on and works in a normal state.

### BACKGROUND

1. Technical Field

The exemplary disclosure generally relates to adapting circuits, and particularly to a minimum output current adapting circuit and motherboard comprising the minimum output current adapting circuit.

2. Description of Related Art

A power supply unit (PSU) used in a motherboard system needs to supply a minimum output current. When a power-on button of the motherboard is triggered, and an actual current drawn from the PSU is lower than the minimum output current, the PSU will stop working and cut off power output altogether, which will cause the motherboard system to malfunction.

A resistor is usually connected to an output of the PSU for increasing the actual output current drawn from the PSU. However, the aforementioned method will cause a decrease in efficiency of the motherboard, and will waste power.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 shows a block diagram of an exemplary embodiment of a motherboard comprising a PSU, a connector, a processor, and a minimum output current adapting circuit.

FIG. 2 shows a circuit diagram of the PSU and the connector shown in FIG. 1.

FIG. 3 shows a circuit diagram of a control unit of the minimum output current adapting circuit shown in FIG. 1.

FIG. 4 shows a circuit diagram of a current adapting unit of the minimum load adapting circuit shown in FIG. 1.

### DETAILED DESCRIPTION

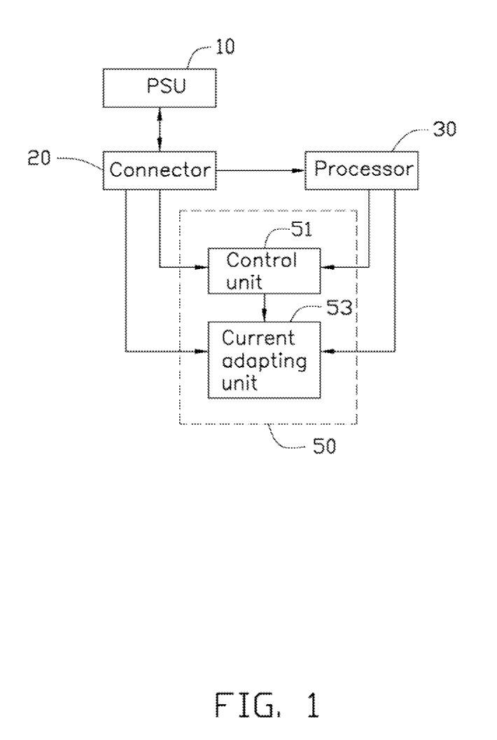

FIG. 1 shows a block diagram of an exemplary embodiment of a motherboard including a PSU 10, a connector 20, a processor 30, and a minimum output current adapting circuit 50 taking currents from the PSU 10. The motherboard can be used in a computer, for example.

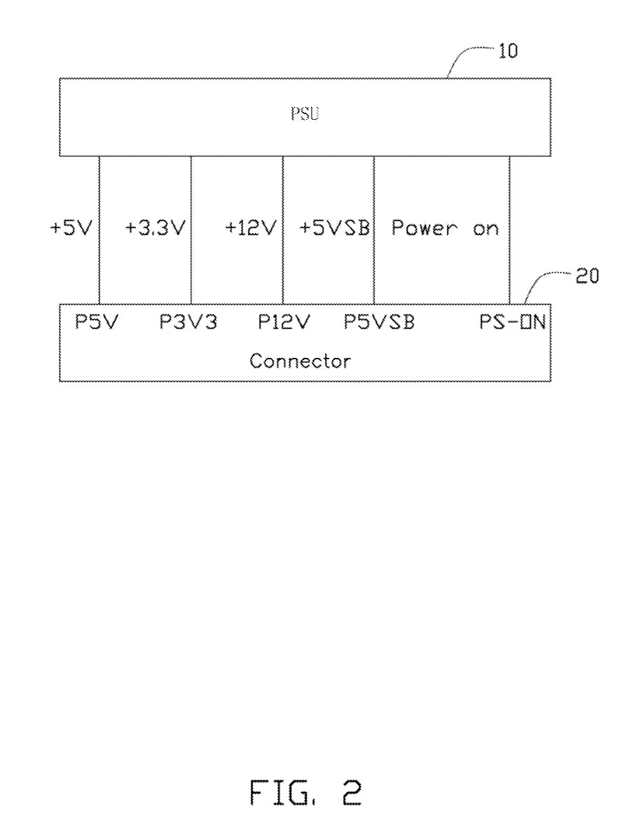

FIG. 2 shows a circuit diagram of the PSU 10 and the connector 20 shown in FIG. 1. The PSU 10 includes a plurality of power port, to output a plurality of powers, such as a +5V power, a +3.3V power, a +12V power, and a +5V standby power for example. The connector 20 is electronically connected to the PSU 10, to transmit the plurality of powers to the electronic components (including the processor 30) of the motherboard. The connector 20 is further electronically connected to the power-on button (not shown) of the computer. When the power-on button is triggered, the connector 20 outputs a power-on signal to the PSU 20. After the PSU 20 receives the power-on signal, the PSU 20 starts to output the plurality of powers to the electronic components. When the processor 30 is powered on and works in a normal state, the processor 30 outputs a power good signal PG.

The connector 20 includes a +5V power pin PSV, a +3.3V power pin P3V3, a +12V power pin P12V, a +5V standby power pin P5VSB, and a power-on pin PS-ON.

Each power pin is electronically connected to one certain power port of the PSU 10. The power-on pin PS-ON is electronically connected to the power-on button and the PSU 10. The power-on pin PS-ON outputs the power-on signal to the PSU 20 when the power-on button is triggered.

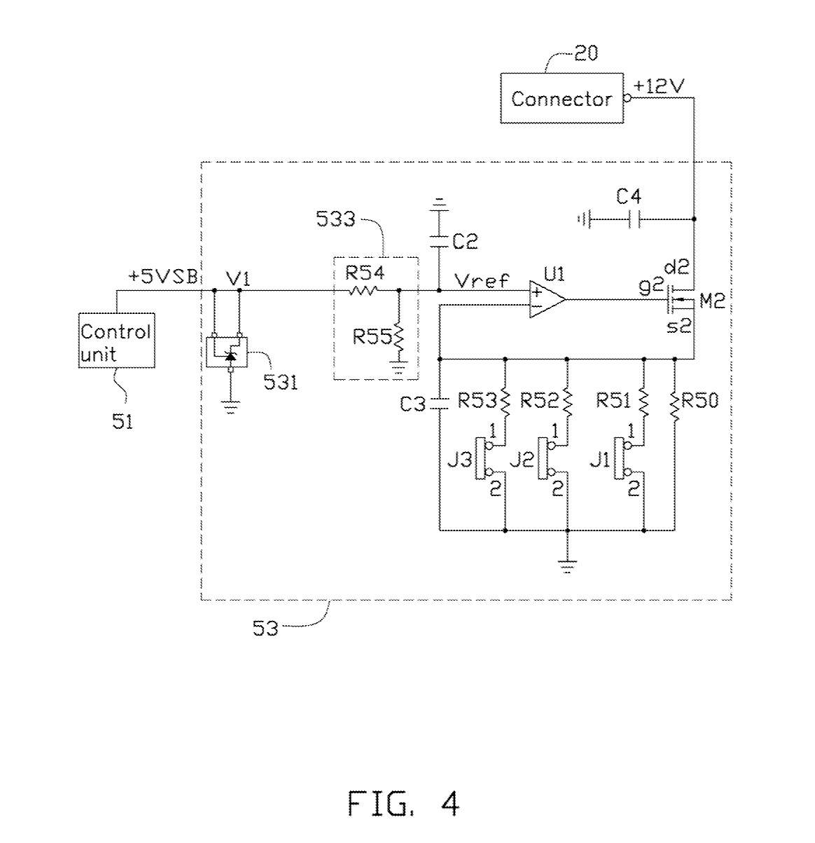

The adapting circuit 50 includes a control unit 51 and a plurality of current adapting unit 53 (there is only one current adapting unit 53 shown in FIGS. 1 and 4). The control unit 51 activates each current adapting unit 53 when the PSU 10 starts to work, and inactivates each current adapting unit 53 when the processor 30 is powered on and works in a normal state. In the exemplary embodiment, the adapting circuit 50 includes three current adapting units 53. A first current adapting unit 53 is electronically connected to a load of the +5V power port of the PSU 10 in parallel; a second current adapting unit 53 is electronically connected to a load of the +3.3V power port of the PSU 10 in parallel; and a third current adapting unit 53 is electronically connected to a load of the +12V power port of the PSU 10 in parallel. Each current adapting unit 53 is configured to increase an output current (that is, a load current) of the corresponding power port, to facilitate the output current of the corresponding power port to be greater than a request minimum output current of the power port.

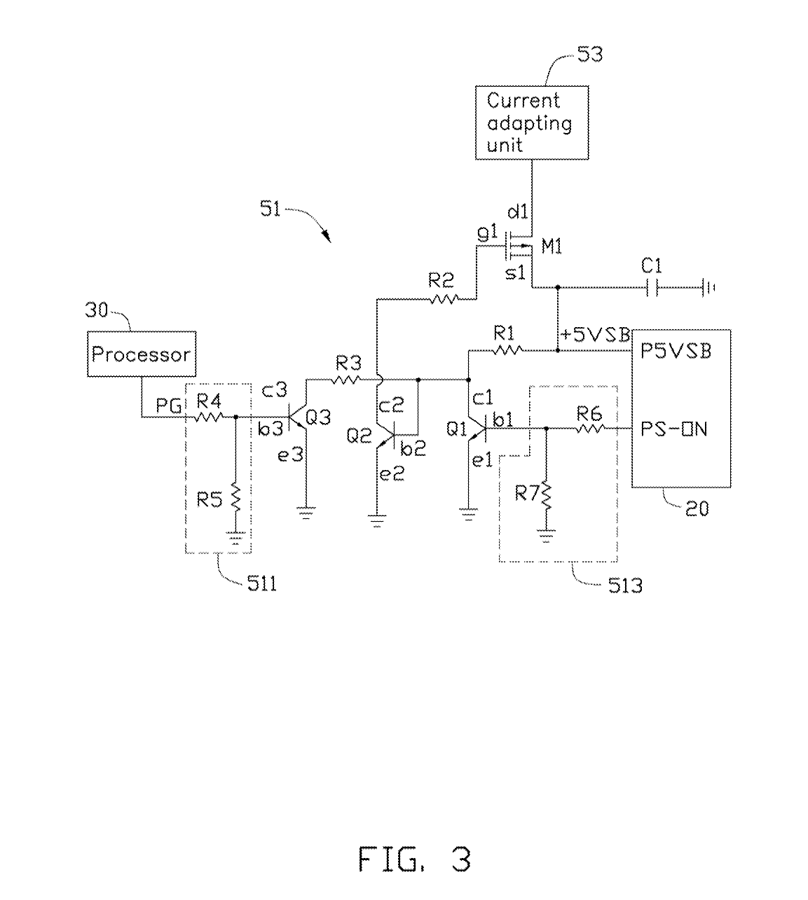

FIG. 3 shows a circuit diagram of a control unit 51 of the minimum output current adapting circuit 50 shown in FIG. 1. The control unit 51 includes a first common-emitter npn type bipolar junction transistor (BJT) Q1, a second common-emitter npn type BJT Q2, a third common-emitter npn type BJT Q3, a P-channel metal-oxide-semiconductor field-effect transistor (MOSFET) M1, a first biasing circuit 511, a second biasing circuit 513, three biasing resistors R1-R3, and a filtering capacitor C1. A base b1 of the first BJT Q1 is electronically connected to the power-on pin PS-ON of the connector 20; a collector c1 of the first BJT Q1 is electronically connected to the +5V standby power pin P5VSB via the biasing resistor R1; and an emitter e1 of the first BJT Q1 is grounded. A base b2 of the second BJT Q2 is electronically connected to a node between the collector c1 and the biasing resistor R1, an emitter e2 of the second BJT Q2 is grounded; and a collector c2 of the second BJT Q2 is electronically connected to a gate g1 of the P-channel MOSFET M1 via the second biasing resistor R2. A base b3 of the third BJT Q3 is electronically connected to the processor 30 to receive the power good signal PG; an emitter e3 of the third BJT Q3 is grounded; and a collector c3 of the third BJT Q3 is electronically connected to collector c2 of the second BJT Q2. A source s1 of the P-channel MOSFET M1 is electronically connected to the +5V standby power pin P5VSB of the connector 20 to receive the +5V standby power, and a drain d1 of the P-channel MOSFET M1 is electronically connected to each current adapting unit 53. A node between the source s1 of the P-channel MOSFET M1 and the +5V standby power pin P5VSB of the connector 20 is grounded via the filtering capacitor C1.

When the power-on button is triggered, the power-on pin PS-ON outputs the power-on signal (that is, a low level voltage signal, e.g. logic 0) to switch off the first BJT Q1, subsequently, the second BJT Q2 and the P-channel MOSFET M1 are switched on in sequence, such that the P-channel MOSFET M1 can make an electrical connection between the +5V standby power pin P5VSB and each current adapting unit 53, thereby activating each current adapting unit 53. After the processor 30 is powered on and works in a normal state, the processor 30 outputs a power good signal PG (that is a high level voltage signal, e.g. logic 1) to switch on the third BJT Q3, subsequently, the second BJT Q2 and the P-channel MOSFET M1 are switched off in sequence, such that the P-channel MOSFET M1 disconnects the +5V standby power pin P5VSB from each current adapting unit 53, thereby inactivating each current adapting unit 53.

The first biasing circuit 511 is electronically connected between the processor 30 and the third BJT Q3. The first biasing circuit 511 includes a first voltage dividing resistor R4 and a second voltage dividing resistor R5 connected in series between the processor 30 and ground. A node between the first and second voltage dividing resistors R4 and R5 is electronically connected to the base b3 of the third BJT Q3.

The second biasing circuit 513 is electronically connected between the power-on pin PS-ON of the connector 20 and the base b1 of the first BJT Q1. The second biasing circuit 513 includes a third voltage dividing resistor R6 and a fourth voltage dividing resistor R7 connected in series between the power-on pin PS-ON of the connector 20 and ground. A node between the third and fourth voltage dividing resistors R6 and R7 are electronically connected to the base b1 of the first BJT Q1.

FIG. 4 shows a circuit diagram of a current adapting unit 53 of the minimum output current adapting circuit 50 shown in FIG. 1. Each current adapting unit 53 includes a reference power supply 531, a first amplifier U1, an N-channel MOSFET M2, a source resistor R50, three optional resistors R51-R53, three jumpers J1-J3, a voltage dividing circuit 533, and three filtering capacitors C2-C4.

The reference power supply 531 is electronically connected to the output of the control unit 51 (that is, the drain d1 of the P-channel MOSFET MD, and a non-inverting input terminal of the first amplifier U1 via the voltage dividing circuit 533.

An inverting input terminal of the first amplifier U1 is electronically connected to a source s2 of the N-channel MOSFET M2; and an output terminal of the first amplifier U1 is electronically connected to the gate g2 of the N-channel MOSFET M2. The drain d2 of the N-channel MOSFET M2 is electronically connected to one power pin of the connector 20, thereby connecting to the corresponding power port of the PSU 10.

In the exemplary embodiment, the drain d2 of the N-channel MOSFET M2 is connected to the +12V power as the only example to illustrate the operation of each current adapting unit 53.

A node between the inverting input terminal of the first amplifier U1 and the source s2 of the N-channel MOSFET M2 is grounded via the source resistor R50. One terminal of each optional resistor is electronically connected to a node between the source s2 of the N-channel MOSFET M2 and the inverting input terminal of the first amplifier U2, another terminal of each optional resistor is grounded via a corresponding jumper.

The voltage dividing circuit 533 includes a fifth voltage dividing resistor R54 and a sixth voltage dividing resistor R55 connected in series between the output of the reference power supply 531 and ground. A node between the fifth and sixth voltage dividing resistors R54 and R55 is electronically connected to the non-inverting input terminal of the first amplifier U1. The non-inverting terminal of the first amplifier U1 is grounded via the filtering capacitor C1, the inverting input terminal of the first amplifier U2 is grounded via the filtering capacitor C3, and the drain d2 of the N-channel MOSFET M2 is grounded via the filtering capacitor C4.

The voltage dividing circuit 533 divides a voltage output from the reference power supply 531, and outputs a reference voltage Vref to the non-inverting input terminal of the first amplifier U1. The reference power supply 531 serves as a zener diode. The reference power supply 531 stabilizes a voltage of output to the voltage dividing circuit 533 on a first voltage V1, thereby stabilizing a voltage of the non-inverting input terminal of the first amplifier on the reference voltage Vref.

Each jumper includes a pin 1 connected to a corresponding optional resistor, and a grounded pin 2. When an electronic connection is constructed between the pin 1 and pin 2 of the jumper, the corresponding optional resistor is electronically connected in parallel with the source resistor R50.

When the power-on button is triggered, the +5V standby power supply is output to each current adapting unit 53 via the control unit 51, the output terminal of the first amplifier U1 outputs a drive current to switch on the N-channel MOSFET M2, such that a current output from the corresponding power port (such as +12V power port in FIG. 4) of the PSU 10 flows through the N-channel MOSFET M2, the source resistor R50, and the selected optional resistor(s), thus, the output current of the corresponding power port of the PSU 10 is increased, which will make the output current of the corresponding power port of the PSU 10 to satisfy the request for minimum output current. The current flows through the N-channel MOSFET M2 can be regulated by operating the jumpers J1-J3. Furthermore, according to a virtual-short characteristic of the amplifier, a voltage (that is, the reference voltage Vref) on the non-inverting input terminal of the first amplifier U1 equates a voltage on the inverting input terminal of the first amplifier U1. Therefore, the current flows N-channel MOSFET M2 can be calculated according to the reference voltage Vref, a resistance of the source resistor R50, and resistance(s) of the selected optional resistor(s).

After the processor 30 is powered on and works in a normal state, the electric connection between the +5V standby power supply and each current adapting unit are cut off by the control unit 51, the first amplifier U1 stops outputting the drive current, and the N-channel MOSFET M2 is switched off, which avoid a continuing output of the current output from the corresponding power port of the PSU 20, and thus can save power.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A current adapting circuit, comprising:
a plurality of current adapting units, each current adapting unit electronically connected to one power port of a power supply unit (PSU), each current adapting unit configured to increase an output current of the power port, to facilitate the output current of the power port to be greater than a request minimum output current of the power port;
a control unit electronically connected to the PSU and a processor powered by the PSU, the control unit activating each current adapting unit when the PSU starts to work, and inactivating each current adapting unit after the processor is powered on and works in a normal state.

2. The current adapting circuit of claim 1, wherein the control unit comprises a first common-emitter npn type bipolar junction transistor (BJT), a second common-emitter npn type BJT, a second common-emitter npn type BJT, and a P-channel metal-oxide-semiconductor field-effect transistor (MOSFET); an input of the first common-emitter npn type BJT is electronically connected to the PSU, an output of the first common-emitter npn type BJT is electronically connected to an input of the second common-emitter npn type BJT; the input of the second common-emitter npn type BJT is further electronically connected to an output of the third common-emitter npn type BJT, and an output of the second common-emitter npn type BJT is electronically connected to the input of the P-channel MOSFET; an input of the third common-emitter npn type BJT is electronically connected to the processor; an output of the P-channel MOSFET is electronically connected to each current adapting unit.

3. The current adapting circuit of claim 2, wherein the P-channel MOSFET is further electronically connected to a power supply; when the PSU starts to works, the PSU outputs a low level voltage signal to switch off the first common-emitter npn type BJT, the P-channel MOSFET make an electrical connection between the power supply and the each current adapting unit, to activate each current adapting unit; after the processor is powered on and works in a normal state, the processor outputs a high level voltage signal to switch on the third common-emitter npn type BJT, the P-channel MOSFET disconnects the power supply from each current adapting unit, to inactivate each current adapting unit.

4. The current adapting circuit of claim 2, where the control unit further comprises a first biasing circuit comprising a first voltage dividing resistor and a second voltage dividing resistor connected in series between the processor and ground, a node between the first and second voltage dividing resistors is electronically connected to the input of the third common-emitter npn type BJT.

5. The current adapting circuit of claim 2, where the control unit further comprises a second biasing circuit comprising a third voltage dividing resistor and a fourth voltage dividing resistor connected in series between the PSU and ground, a node between the third and fourth voltage dividing resistors is electronically connected to the input of the first common-emitter npn type BJT.

6. The current adapting circuit of claim 3, wherein each current adapting unit comprises a first amplifier, a N-channel MOSFET, and a source resistor; a non-inverting input terminal of the first amplifier is electronically connected to a drain of the P-channel MOSFET, an inverting input terminal of the first amplifier is electronically connected to a source of the N-channel MOSFET, and an output terminal of the first amplifier is electronically connected to a gate of the N-channel MOSFET; a drain of the N-channel MOSFET is electronically connected to a corresponding power port; a node between the inverting input terminal of the first amplifier and the source of the N-channel MOSFET is grounded via the source resistor.

7. The current adapting circuit of claim 6, wherein when the P-channel MOSFET of the control unit is switched on, the non-inverting input terminal of the first amplifier obtains a reference voltage from the power supply, and the first amplifier outputs a drive current to switch on the P-channel MOSFET, the corresponding power port of the PSU outputs a current flowing through the P-channel MOSFET and the source resistor, to increase the output current of the corresponding power port.

8. The current adapting circuit of claim 6, wherein the current adapting unit further comprises a reference power supply electronically connected between the output of the P-channel MOSFET and the non-inverting input terminal of the first amplifier, the reference power supply serve as a zener diode, to maintain a voltage of the non-inverting input terminal of the first amplifier to the reference voltage.

9. The current adapting circuit of claim 6, wherein the current adapting unit further comprises a plurality of optional resistors and a plurality of jumpers, one terminal of each optional resistor is electronically connected to a node between the inverting input terminal of the first amplifier and the source of the N-channel MOSFET, and the other terminal of each optional resistor is grounded via a corresponding jumper.

10. A motherboard, comprising:
a power supply unit (PSU) comprising a plurality of power ports;
a processor powered by the PSU; and
a current adapting circuit, comprising:
a connector electronically connected to the plurality of power ports of the PSU;
a plurality of current adapting units each current adapting unit electronically connected to one of the power ports via the connector, each current adapting unit increasing an output current of the corresponding power port, to facilitate the output current of the corresponding power port to be greater than a request minimum output current of the corresponding power port; and
a control unit electronically connected to the PSU and a processor powered by the PSU, the control unit activating each current adapting unit when the PSU starts to work, and inactivating each current adapting unit after the processor is powered on and works in a normal state.

11. The motherboard of claim 10, wherein the control unit comprises a first common-emitter npn type BJT, a second common-emitter npn type BJT, a second common-emitter npn type BJT, and a P-channel MOSFET; an input of the first common-emitter npn type BJT is electronically connected to the PSU, an output of the first common-emitter npn type BJT is electronically connected to an input of the second common-emitter npn type BJT; the input of the second common-emitter npn type BJT is further electronically connected to an output of the third common-emitter npn type BJT, and an output of the second common-emitter npn type BJT is electronically connected to the input of the P-channel MOSFET; an input of the third common-emitter npn type BJT is electronically connected to the processor; an output of the P-channel MOSFET is electronically connected to each current adapting unit.

12. The motherboard of claim 11, wherein the P-channel MOSFET is further electronically connected to a power supply; when the PSU starts to works, the PSU outputs a low level voltage signal to switch off the first common-emitter npn type BJT, the P-channel MOSFET make an electrical connection between the power supply and the each current adapting unit, to activate each current adapting unit; after the processor is powered on and works in a normal state, the processor outputs a high level voltage signal to switch on the third common-emitter npn type BJT, the P-channel MOSFET disconnects the power supply from each current adapting unit, to inactivate each current adapting unit.

13. The motherboard of claim 11, where the control unit further comprises a first biasing circuit comprising a first voltage dividing resistor and a second voltage dividing resistor connected in series between the processor and ground, a node between the first and second voltage dividing resistors is electronically connected to the input of the third common-emitter npn type BJT.

14. The motherboard of claim 11, where the control unit further comprises a second biasing circuit comprising a third voltage dividing resistor and a fourth voltage dividing resistor connected in series between the PSU and ground, a node between the third and fourth voltage dividing resistors is electronically connected to the input of the first common-emitter npn type BJT.

15. The motherboard of claim 12, wherein each current adapting unit comprises a first amplifier, a N-channel MOSFET, and a source resistor; a non-inverting input terminal of the first amplifier is electronically connected to a drain of the P-channel MOSFET, an inverting input terminal of the first amplifier is electronically connected to a source of the N-channel MOSFET, and an output terminal of the first amplifier is electronically connected to a gate of the N-channel MOSFET; a drain of the N-channel MOSFET is electronically connected to a corresponding power port; a node between the inverting input terminal of the first amplifier and the source of the N-channel MOSFET is grounded via the source resistor.

16. The motherboard of claim 15, wherein when the P-channel MOSFET of the control unit is switched on, the non-inverting input terminal of the first amplifier obtains a reference voltage from the power supply, and the first amplifier outputs a drive current to switch on the P-channel MOSFET, the corresponding power port of the PSU outputs a current flowing through the P-channel MOSFET and the source resistor, to increase the output current of the corresponding power port.

17. The motherboard of claim 15, wherein the current adapting unit further comprises a reference power supply electronically connected between the output of the P-channel MOSFET and the non-inverting input terminal of the first amplifier, the reference power supply serve as a zener diode, to maintain a voltage of the non-inverting input terminal of the first amplifier to the reference voltage.

18. The motherboard of claim 15, wherein the current adapting unit further comprises a plurality of optional resistors and a plurality of jumpers, one terminal of each optional resistor is electronically connected to a node between the inverting input terminal of the first amplifier and the source of the N-channel MOSFET, and the other terminal of each optional resistor is grounded via a corresponding jumper.
